(19) United States
(12) Patent Application Publication
(10) Pub. No.: US 2022/0158391 A1
(43) Pub. Date: May 19, 2022

(54) IN-LINE FUSEHOLDER QUICK CONNECTION

(71) Applicant: Littelfuse, Inc., Chicago, IL (US)

(72) Inventor: Juan Antonio Guerrero, Chicago, IL (US)

(73) Assignee: Littelfuse, Inc., Chicago, IL (US)

(21) Appl. No.: 17/097,332

(22) Filed: Nov. 13, 2020

(51) Int. Cl. H01R 13/684; H01H 85/20; H01H 85/22

(52) U.S. Cl. CPC H01R 13/684; H01H 85/22; H01H 85/2015

(57) ABSTRACT

An in-line fuseholder quick connection device is disclosed. In addition to allowing easy insertion of a fuse cartridge, the in-line fuseholder quick connection device includes easy wire connection using spring clamps, enabling the customer to avoid wire terminal crimping processes.

### FIELD OF THE DISCLOSURE

Embodiments of the present disclosure relate to fuses and, more particularly, to a technique for quick and easy connection of a fuse cartridge and wires to a fuseholder device.

### BACKGROUND

In the field of electronics, one way to connect a device to another device is to connect them using a copper wire. The copper wire is shielded with a non-conductive material, so each end of the copper wire is first stripped, exposing the copper material. The exposed copper portions of each wire are then twisted and connected together, such as with electrical tape or by soldering. Solder connectors, seal connectors, and push-in wire connectors are also available to facilitate this process. Quick splice connectors actually cut through the wire sheathing, eliminating the need to first strip the wire. Wago connectors enable multi-wire connections to be made.

Many devices employ fuses to protect downstream components from overcurrent and overvoltage events. The fuse may be added to a fuseholder before being added to a circuit. Some fuseholders are pre-fabricated with wires terminating from each side of the fuseholder. The addition of the fuse to the device may thus involve a time-consuming wire-terminal crimping process that some customers would rather avoid.

It is with respect to these and other considerations that the present improvements may be useful.

### SUMMARY

This Summary is provided to introduce a selection of concepts in a simplified form that are further described below in the Detailed Description. This Summary is not intended to identify key or essential features of the claimed subject matter, nor is it intended as an aid in determining the scope of the claimed subject matter.

An exemplary embodiment of an in-line fuseholder quick connection device in accordance with the present disclosure may include a housing, a fuse carrier that includes a receiving chamber for inserting a fuse cartridge, a first fuse clip, and a second fuse clip. The fuse carrier moves from a horizontal position along a top portion of the housing to an angled position extending outside the housing for receiving the fuse cartridge. The fuse carrier returns to the horizontal position once the fuse cartridge is inserted inside the receiving chamber. The first fuse clip connects to the fuse cartridge at one end and the second fuse clip connects to the fuse cartridge at the other end.

An exemplary embodiment of a method to connect an in-line fuseholder quick connection device to a circuit in accordance with the present disclosure, where the circuit includes a first wire and a second wire, includes moving a fuse carrier from a horizontal position in a housing to an angled position, wherein the fuse carrier extends above a top portion of the housing, inserting a fuse cartridge into a receiving chamber of the fuse carrier, where the fuse cartridge is connected to first and second fuse clips, moving the fuse carrier back to the horizontal position in the housing, and connecting the first wire to the housing.

### BRIEF DESCRIPTION OF THE DRAWINGS

FIG. 1 is a perspective view diagram illustrating an in-line fuseholder quick connection device, in accordance with exemplary embodiments;

FIG. 2 is a perspective cutaway diagram illustrating the in-line fuseholder quick connection device of FIG. 1, in accordance with exemplary embodiments;

FIG. 3 is an exploded perspective diagram illustrating the in-line fuseholder quick connection device of FIG. 1, in accordance with exemplary embodiments;

FIGS. 4A and 4B are perspective views of in-line fuseholder quick connection devices, in accordance with exemplary embodiments; and

FIGS. 5A-5J are perspective and cutaway diagram illustrating the operation of the in-line fuseholder quick connection device of FIG. 1, in accordance with exemplary embodiments.

### DETAILED DESCRIPTION

An in-line fuseholder quick connection device is disclosed herein. In addition to allowing easy insertion of a fuse cartridge, the in-line fuseholder quick connection device includes easy wire connection using spring clamps, enabling the customer to avoid wire terminal crimping processes. The in-line fuseholder quick connection device can be applied to LED lighting systems, Smart Meters, Junction Boxes, as well as other applications where additional protection is desired.

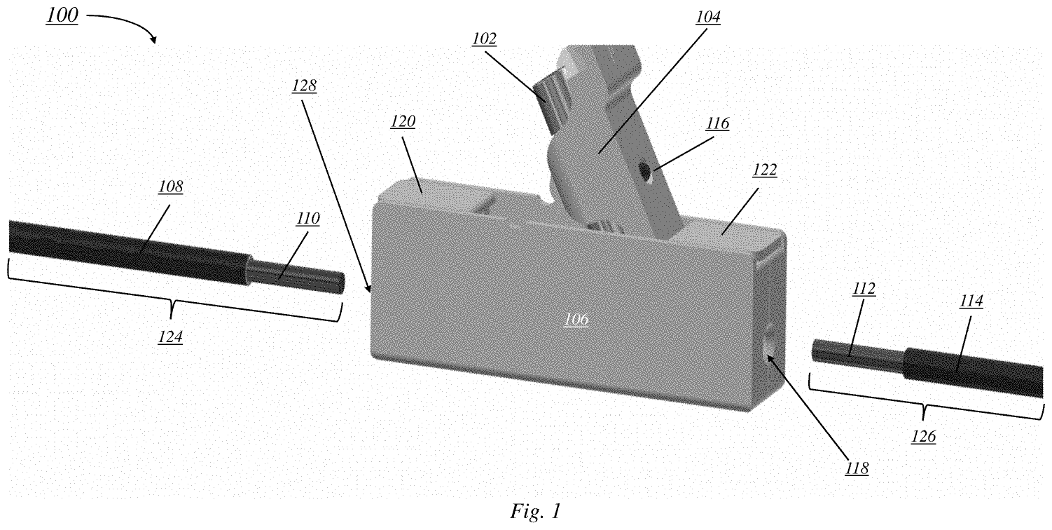

FIG. 1 is a representative perspective diagram of an in-line fuseholder quick connection device 100 for connecting a fuse to a circuit or other device, according to exemplary embodiments. The in-line fuseholder quick connection device 100, also referred to herein as device 100 or fuseholder device 100, consists of a housing 106 and a fuse carrier 104 for receiving a fuse cartridge 102. In an exemplary embodiment, the in-line fuseholder quick connection device 100 is designed for easy connection to a variety of different circuits. In-line fuse holders are holders that connect anywhere along a circuit to protect other circuit components. The fuseholder device 100 housing is a receptacle for enclosing the fuse cartridge 102. Where some fuseholder devices include wires or terminals that extend from each end of the housing 106, the in-line fuseholder quick connection device 100 is without terminals, allowing users to add their own wiring to the device.

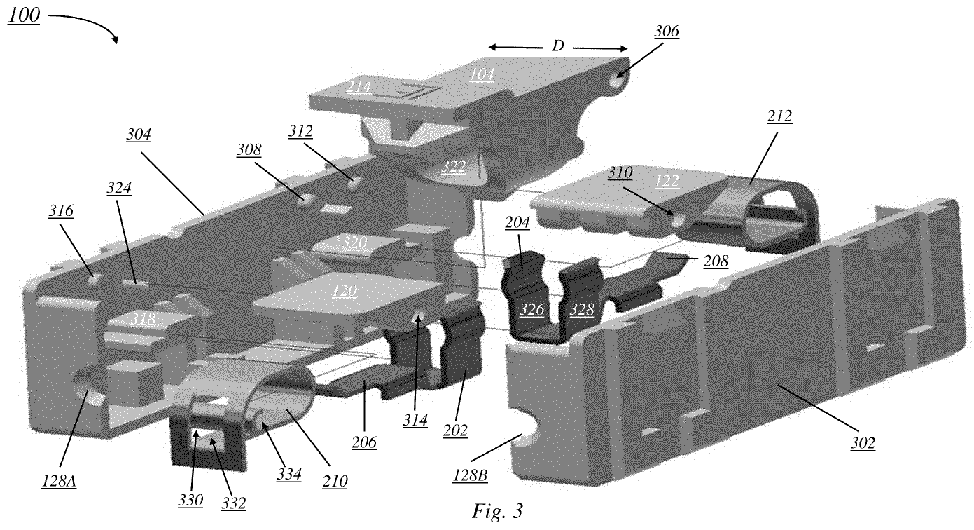

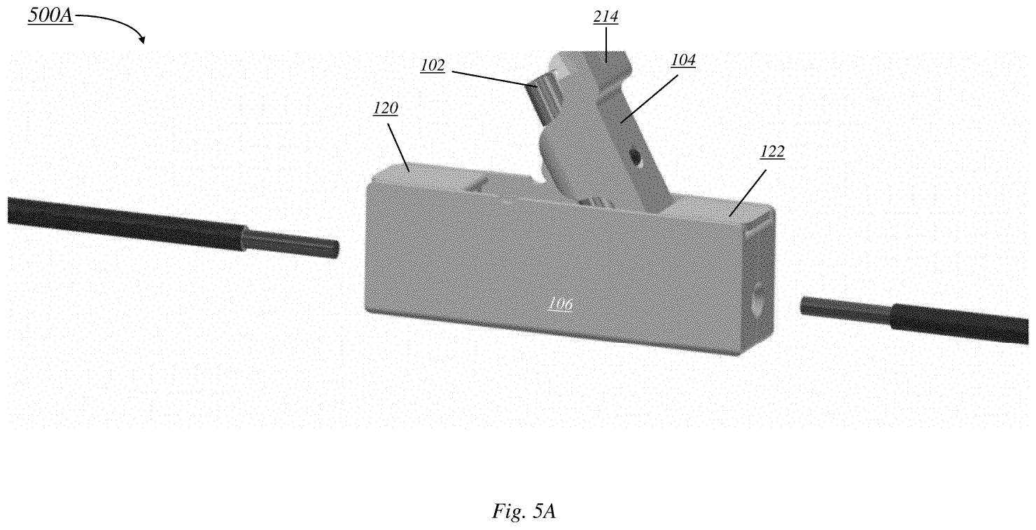

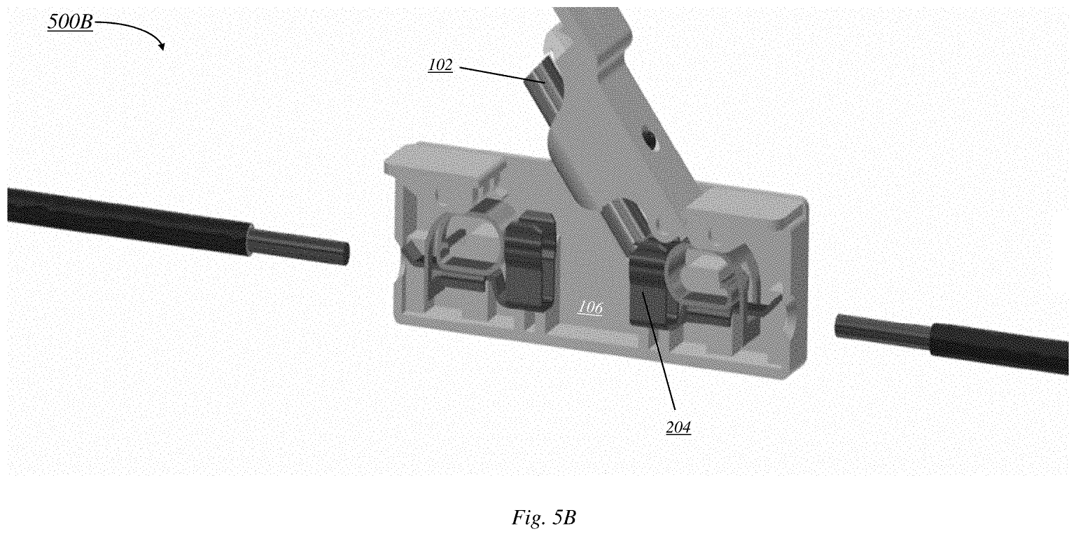

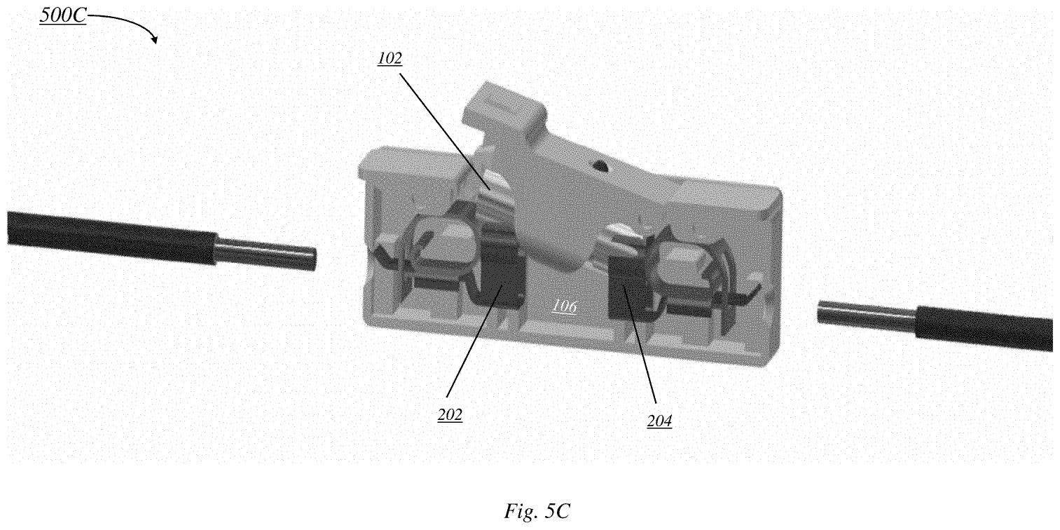

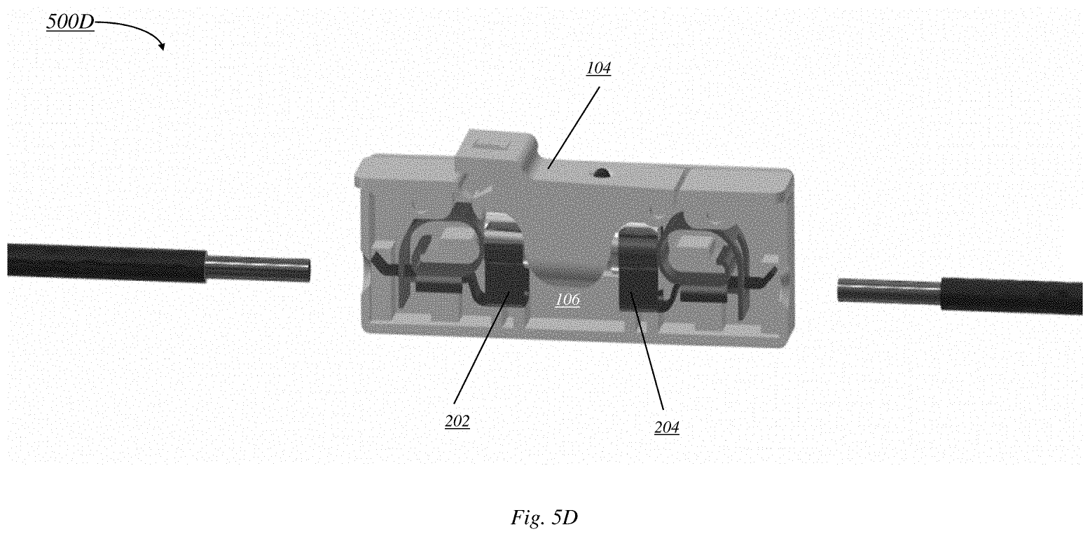

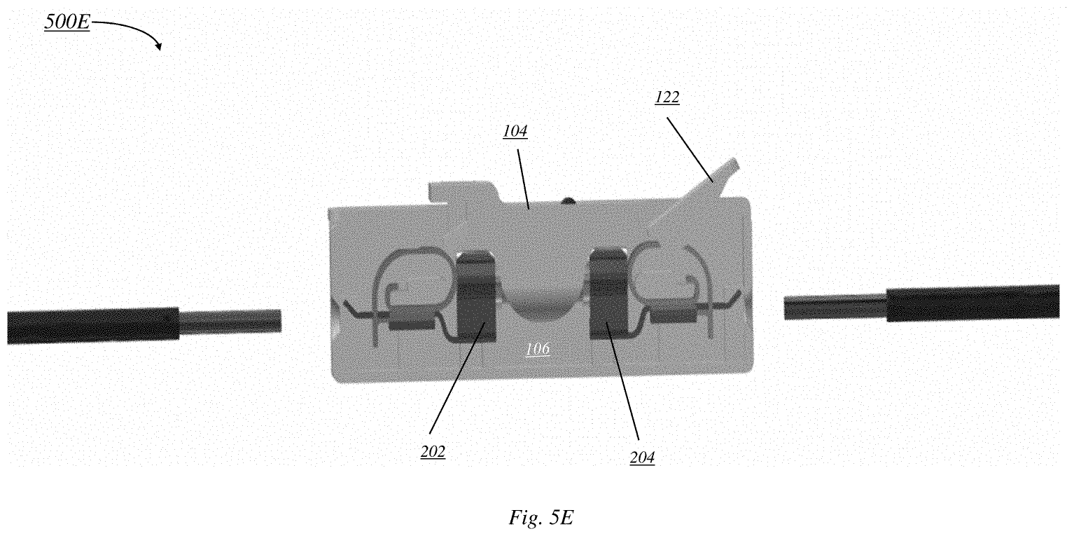

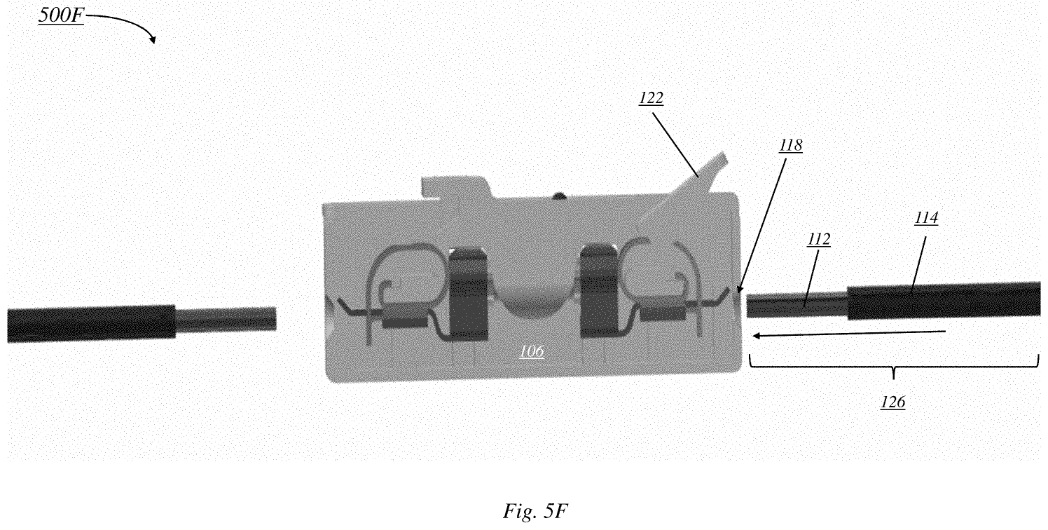

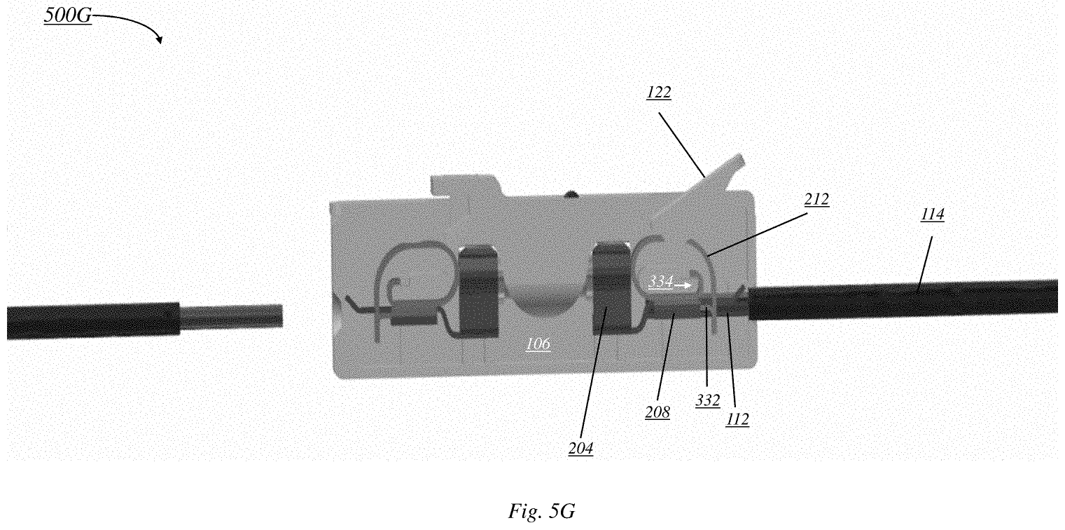

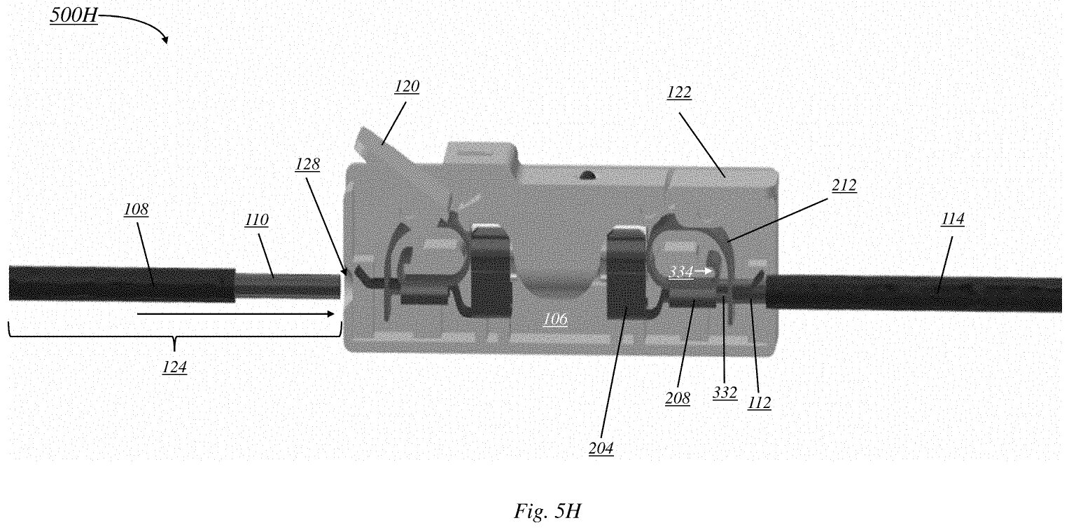

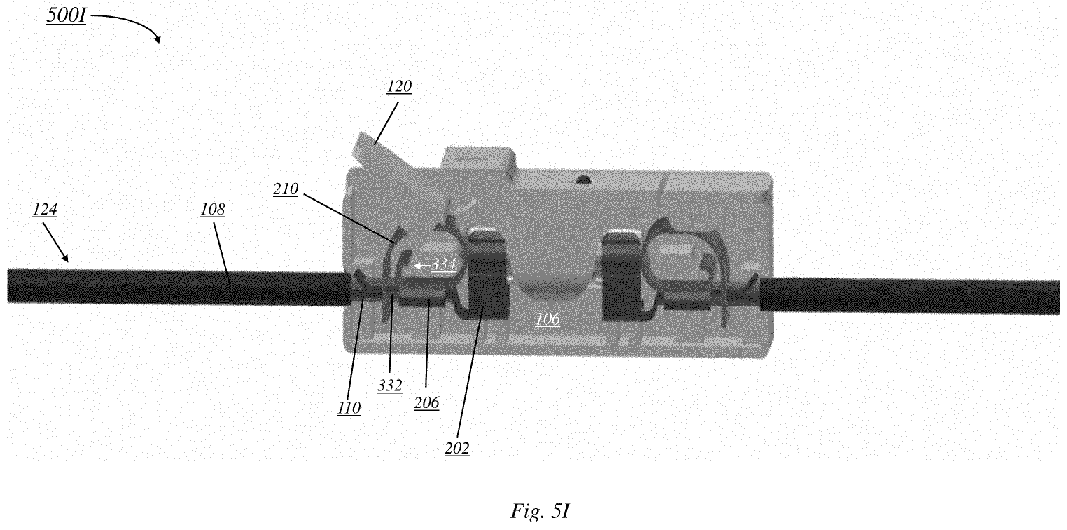

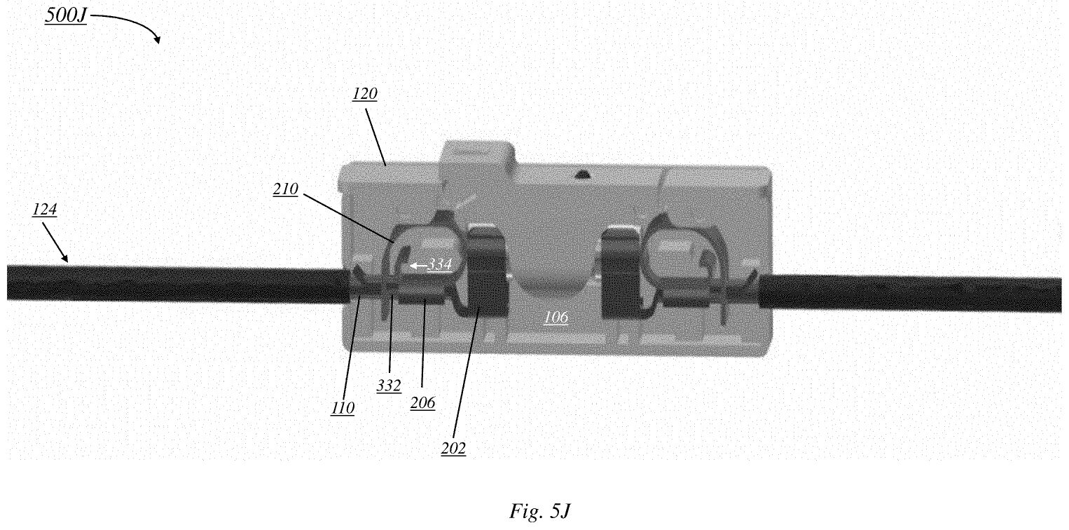

In FIG. 1, the fuse carrier 104 is positioned at an angle relative to the fuse housing 106, enabling the fuse cartridge 102 to be easily inserted into the fuse carrier. The fuse housing 106 further includes a left leverage cover 120 on its left side and a right leverage cover 122 on its right side. A left wire 124 is disposed on a left side of the in-line fuseholder quick connection device 100 while a right wire 126 is disposed on a right side of the device. The left wire 124 features a non-conductive casing or covering 108 as well as exposed copper wire 110. Similarly, the right wire 126 features a non-conductive casing 114 as well as exposed copper wire 112. For establishing electrical connections, wires are typically stripped so as to expose a portion of electrically conductive metal (typically copper) as shown. The left leverage cover 120 facilitates receiving the copper portion 110 of the left wire 124 while the right leverage cover 122 facilitates receiving the copper portion 112 of the right wire 126. A right side wire receiving receptacle 118 is shown for receiving the copper portion 112 of the right wire into the housing 106 of the in-line fuseholder quick connection device 100; a left side wire receiving receptacle 128 is not visible in FIG. 1, but is apparent in other views of the device 100 (see, e.g., FIGS. 3 and 5H).

Optionally, the fuse carrier 104 includes an LED indicator 116 that is disposed in a cutout portion of the fuse carrier. In an exemplary embodiment, the LED indicator 116 lights (turns on) when the fuse cartridge 102 blows on a short-circuit or overload event. The LED indicator 116 thus provides notification indicating that the circuit is open and the fuse needs to be replaced. In exemplary embodiments, when the fuse housing 106 is used on multiple poles and a circuit branch is protected by one of the poles, the LED indicator 116 will help the technician to identify which of the poles needs attention.

In exemplary embodiments, the in-line fuseholder quick connection device 100 offers to customers a solution to combine wire connectors and an in-line fuseholder with different wire colors, gauges, and lengths, and also provides a crimping-less solution for customers that prefer to use their own wires. Where some fuseholder devices already have attached wires, the in-line fuseholder quick connection device 100 enables the customer to color-match wires as desired. Particularly where multiple fuseholder devices are used in a common area, this color-matching may make it easier to identify and perform maintenance on a circuit system.

Further, in exemplary embodiments, the in-line fuseholder quick connection device 100 can be applied to LED lighting systems, Smart Meters, Junction Boxes, as well as other applications where additional protection is desired. Some LED lighting applications use Wago connectors in low amperage rating environments. The Wago connectors may be coupled with the in-line fuseholder quick connection device 100 for these and other applications.

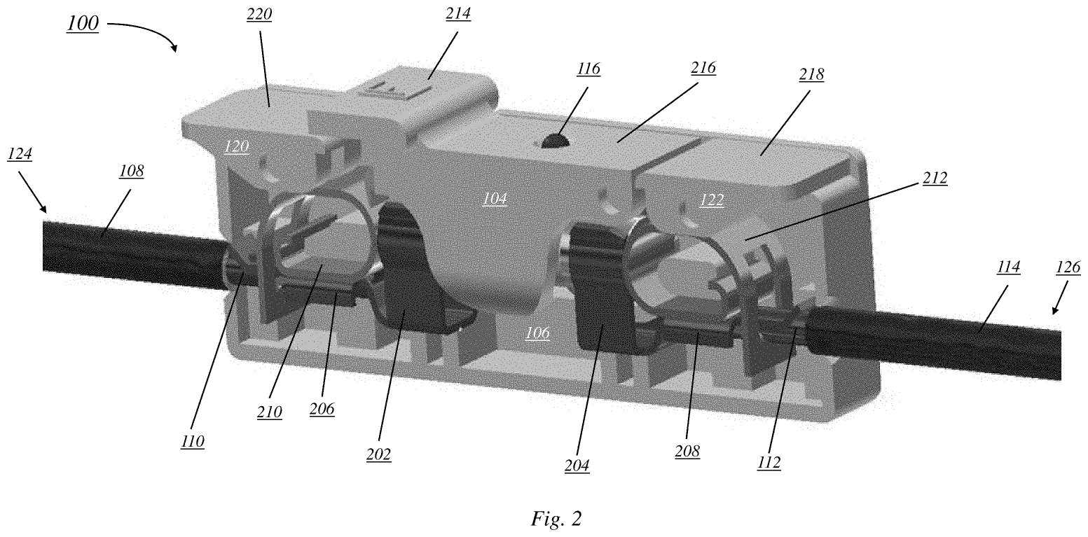

FIG. 2 is a representative perspective cutaway diagram of the in-line fuseholder quick connection device 100 of FIG. 1, according to exemplary embodiments. While in FIG. 1, the fuse carrier was positioned at an upward angle relative to the housing 106, the diagram of FIG. 2 shows the fuse carrier 104 horizontally disposed within a space of the housing 106, such that a top portion 216 of fuse carrier 104 is adjacent to and in the same plane as a top portion 218 of the right leverage cover 122. Further, in exemplary embodiments, both top portions 216 and 218 are in the same plane as a top portion 220 of the left leverage cover 120.

A fuse carrier lever 214 is disposed between top portions 220 and 216, and is in a second, slightly elevated plane. In the horizontal positions of diagram 200, the top portion 220, lever 214, top portion 216, and top portion 218 thus form a top structure of the rectangular cube-shaped fuseholder quick connection device 100, in one embodiment. The in-line fuseholder quick connection device 100 may also be cube-shaped, oval, cylindrical, or other shapes, and the representative drawings are not meant to limit the overall shape of the device.

The copper portion 110 of the left wire 124 is fully within the housing 106 while the left wire casing or covering 108 is outside the housing. Similarly, the copper portion 112 of the right wire 126 is fully within the housing 106 while the right wire casing or covering 114 is outside the housing. The in-line fuseholder quick connection device 100 includes a left fuse clip 202 and a right fuse clip 204. In an exemplary embodiment, the fuse clips 202, 204 are made of an electrically conductive material, such as copper.

In an exemplary embodiment, the fuse clips 202, 204 are designed to accommodate the fuse cartridge 102. The left fuse clip 202 includes vertically disposed portions, for receiving the left side of the fuse cartridge 102, as well as a horizontally disposed base 206. Similarly, the right fuse clip 204 includes vertically disposed portions, for receiving the right side of the fuse cartridge 102, as well as a horizontally disposed base 208. The base 206 electrically connects the fuse cartridge 102 to the (copper portion 110) of the left wire 124, and the base 208 of electrically connects the fuse cartridge to the (copper portion 112) of the right wire 126. In this way, the fuse cartridge 102 may be electrically connected to another device or circuit. In exemplary embodiments, the lower sides of the horizontally disposed bases 206 (left fuse clip 202) and 208 (right fuse clip 204) feature roughened surfaces such that, when they are mated with the respective copper cables 110 and 112, provide traction between the two surfaces (the base and the cable), thus making the cables more difficult to disengage from the fuseholder 100. The left fuse clip 202 and right fuse clip 204 are illustrated in more detail in the exploded perspective view of FIG. 3, below.

Also shown in FIG. 2 are left spring clamp 210 and right spring clamp 212, which are also known as clam springs, due to their clam-like shape. The left spring clamp 210 is connected to and controlled by the left leverage cover 120 while the right spring clamp 212 is connected to and controlled by the right leverage cover 122. Once activated, as described in more detail, below, the left spring clamp 210 establishes a tight coupling between the left wire exposed copper 110 and the base 206, with the tightness being sufficient for electrical transmission between the two conductive components 110 and 206; similarly, the right spring clamp 212 establishes a tight coupling between the right wire exposed copper 112 and the base 208 sufficient for electrical transmission between the conductive components 112 and 208. In exemplary embodiments, the left and right spring clamps 210 and 212 are made of a metal material, such as steel. Thus, once the left and right spring clamps 210, 212 are engaged, an electrical connection between the fuse cartridge 102 and circuits or devices connected to the left and right wires 124, 126 is established. In exemplary embodiments, the in-line fuseholder quick connection device 100 optimally emulates the ease of use characteristics of many wire connection devices, as well as facilitating ease of installation of the fuse cartridge.

To summarize, the left fuse clip 202, either connected to or formed at the same time as the base 206, is compressed together with the copper portion 110 of the left wire 124 by the left spring clamp 210, which is activated by the external leverage cover 120. Similarly, the right fuse clip 204, either connected to or formed at the same time as the base 208, is compressed together with the copper portion 112 of the right wire 126 by the right spring clamp 212, which is activated by the external leverage cover 122. In this way, the in-line fuseholder quick connection device 100 emulates preferred features of popular wire coupling devices, such as Wago connectors.

FIG. 3 is a representative exploded perspective diagram of the in-line fuseholder quick connection device 100 of FIG. 1, according to exemplary embodiments. For ease of discussion, the right fuse clip 204 is described herein in detail, although the left fuse clip 202 is similarly configured and operated. The right fuse clip 204 is shown in more detail, with first vertical portion 326 and second vertical portion 328 being somewhat parallel to one another, and connected to the base 208. In an exemplary embodiment, the first vertical portion 326, the second vertical portion 328, and the base 208 of the right fuse clip 204 are formed as a single unitary metallic structure.

In an exemplary embodiment, the first vertical portion 326 and second vertical portion 328 of the right fuse clip 204 are initially vertically disposed apart at a distance slightly less than the diameter of the fuse cartridge 102. Further, the first vertical portion 326 is convex-shaped along its upper portion. Similarly, the second vertical portion 328 is convex-shaped along its upper portion, where the two convex shapes are in the same plane facing one another.

The fuse cartridge 102 is to be placed in a receiving chamber 322 of the fuse carrier 104 when the fuse carrier is in an angled position (e.g., FIG. 1). Once the fuse carrier 104 is returned to a horizontal position in the housing 106 with the fuse cartridge 102 in place, the fuse cartridge will press against and slightly separate the first vertical portion 326 and second vertical portion 328 of the right fuse clip 204 (as well as the first and second vertical portions of the left fuse clip 202). The vertical portions of the respective fuse clips thus act as springs, by yielding slightly to accommodate the presence of the fuse carrier 104. This spring action of the vertical portions 326, 328 (and similar vertical portions of the left fuse clip 202) ensures an electrical connection is established and maintained between the left fuse clip 202, the fuse cartridge 102, and the right fuse clip 204. Further, the convex shaping of the vertical portions establishes a seating position for the fuse cartridge 102.

The left spring clamp 210 and right spring clamp 212 are also shown in FIG. 3. In an exemplary embodiment, the spring clamps 210, 212 are formed as a single, unitary structure. For ease of discussion, the left spring clamp 210 is described, herein in detail, although the right spring clamp 212 is similarly configured and operated. The left spring clamp 210 includes a horizontal opening 330 through which the exposed copper 110 of the left wire 124 is inserted. (Left side wire receiving receptacle 128 for receiving the exposed copper 110 was not visible in FIG. 1 but is shown here in two parts, 128A and 128B.) In an exemplary embodiment, the spring clamp 210 is formed from a rectangular piece of metal with a smaller rectangular cutout 332 being flattened horizontally, leaving the opening 330 at one end. In the example of FIG. 3, the opening 330 and associated cutout 332 are rectangular in shape, though they may assume a number of different shapes. Before forming the spring clamp 210, the rectangular metal piece is formed on a cold working condition, followed by an annealing process for stress relief, and shaped into a generally oval shape, with a final inward curl of the end opposite the opening end being disposed inside the oval shape, with the inward curl 334 being disposed against the opening 330. The opening cutout 332 is bent downward from an original vertical position to a horizontal position, such that the cutout is disposed beneath the inward curl 334. In an exemplary embodiment, the opening cutout 332, disposed horizontally, and the inward curl 334 are coupled tightly together, but are able to move slightly if an object is inserted therebetween, thus forming the clamping feature of the spring clamp 210.

Recall that the spring clamps 210, 212 are for receiving the copper portions 110, 112 of respective wires 124, 126. In exemplary embodiments, the copper portions 110, 112 are inserted between the inward curl 334 and the horizontally flattened opening cutout 332 of respective spring clamps 210, 212 so as to tightly grip the copper portions. Additionally, in exemplary embodiments, the respective bases 206, 208 of the left and right fuse clips 202, 204 are inserted between the inward curl 334 and the opening cutout 332 of respective spring clamps 210, 212. The left spring clamp 210 thus ensures an electrical connection between the copper portion 110 of the wire 124 and the base 206 of the left fuse clip 202. Similarly, the right spring clamp 212 ensures an electrical connection between the copper portion 112 of the wire 126 and the base 208 of the right fuse clip 204.

The exploded perspective diagram of FIG. 3 further illustrates how the left leverage cover 120, fuse carrier 104, and right leverage cover 122 are connected to the housing 106 of the in-line fuseholder quick connection device 100, in exemplary embodiments. The housing 106 of the in-line fuseholder quick connection device 100 includes a front housing portion 302 and a back housing portion 304. For ease of discussion, the back housing portion 304, whose features are more visible, is described herein in detail, although the front housing portion 302 is similarly configured. First, the fuse carrier 104 includes a connection cylinder 306 (circular opening) on its front portion. The cylinder 306 may extend along the entire depth of the fuse carrier 104 such that a second circular opening is present on the distal side (not shown) of the fuse carrier. Alternatively, there may be two cylinders 306 (one of which is not visible), each extending to a predetermined depth that is less than the depth, D, of the fuse carrier 104. The fuse carrier 104 connects to the back housing portion 304 of the in-line fuseholder quick connection device 100 by disposing the cylinder 306 over a back housing boss 308. Similarly, the fuse carrier 104 is connected to the front housing portion 302 by a boss (not shown). The coupling of the cylinder 306 to the bosses 308 enables the fuse carrier 104 to rotate from a horizontal position (e.g., FIG. 2) to an angled position (e.g., FIG. 1), for receiving the fuse cartridge 102, then back again to the horizontal position once the fuse cartridge is in place.

Further, in an exemplary embodiment, the fuse carrier 104 is moved from the horizontal position to the angled position by pressing on the lever 214. In an exemplary embodiment, the fuse carrier 104 is a quick-release feature of the in-line fuseholder quick connection device 100, which is activated by pressing on the lever 214. The fuse carrier 104 does not contain a spring. Instead, the fuse carrier 104 is sustained in the horizontal position by the force offered by the fuse clips 202 and 204. The fuse carrier 104 is moved from the horizontal position to the angled position by lifting the lever 214, then returned to the horizontal position by pressing the lever downward.

Similar to the fuse carrier 104, in exemplary embodiments, the left leverage cover 120 and right leverage cover 122 feature connection cylinders 314 and 310, respectively. These enable the leverage covers to be connected to the front and back housing portions 302, 304. A back housing boss 312 and associated front housing boss (not shown) enables connection of the right leverage cover 122 therebetween. A back housing boss 316 and associated front housing boss (not shown) enables connection of the left leverage cover 120 therebetween. As with the fuse carrier 104, these connections enable rotatable movement of the left and front leverage covers 120, 122 from a horizontal position (as in FIGS. 1 and 2) to angled positions (as illustrated and explained further below).

The exploded perspective diagram of FIG. 3 further features a surface 318 for supporting the left spring clamp 210, a surface 320 for supporting the right spring clamp 212, and a stopper 324, which maintains the position of the left leverage cover 120 of the clamp spring 210. Other structures within the housing 106 are designed to increase the structural resistance of the front and back housing portions 302 and 304, in some embodiments.

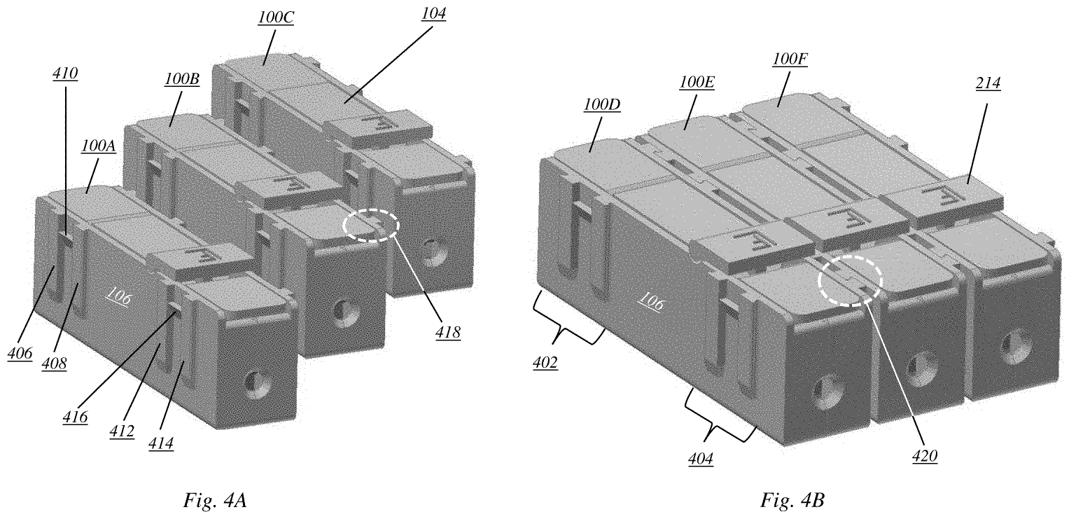

FIGS. 4A and 4B are representative perspective diagrams of multiple in-line fuseholder quick connection devices such as the in-line fuseholder quick connection device 100, according to exemplary embodiments. These diagrams illustrate features external to the housing 106 that may facilitate connection of a single fuseholder devices 100 on a single pole (such as an outdoor electrical pole) or multiple fuseholder devices 100 to multiple poles, as appropriate. In exemplary embodiments, the in-line fuseholder quick connection devices 100 feature a lock system to engage to desired poles.

In FIG. 4A, three in-line fuseholder quick connection devices 100A, 100B, and 100C are shown. The devices 100A, 100B, 100C do not appear to be connected together. In FIG. 4B, three in-line fuseholder quick connection devices 100D, 100E, and 100F are shown. The devices 100D, 100E, 100F are connected together via interlocking means. The devices of FIGS. 4A and 4B may variously be referred to separately (100A-100F) or collectively, as “in-line fuseholder quick connection devices 100”, “fuseholder devices 100” or “devices 100”). On the left side of device 100D, an H-shaped back protuberance 402 and a second H-shaped front protuberance 404 are shown. The H-shaped protuberances are also shown on the left side of device 100A, one at the back and one at the front, and will also be described as back protuberance 402 and front protuberance 404, respectively.

As indicated in the fuseholder device 100A, the back protuberance 402 consists of a first vertical ridge 406, a second vertical ridge 408, and a horizontal ridge 410. Similarly, the front protuberance 404 consists of a first vertical ridge 412, a second vertical ridge 414, and a horizontal ridge 416. Though not fully visible, these H-shaped protuberances are also on the opposing sides of each fuseholder device 100. In exemplary embodiments, the vertical ridges (406, 408, 412, 414) of the H-shaped protuberances 402, 404 are rectangular trapezoids. Trapezoids are convex quadrilaterals having four sides, with one pair of parallel sides (bases), and two other sides (legs). In one embodiment, the rectangular trapezoids are isosceles trapezoids, with one small base and a second larger base. As shown in FIG. 4A, a trapezoid-shaped top surface 418 of one of the vertical ridges is visible, with the small base being flush against the side of the housing 106 and the larger base extending outward.

In FIG. 4B, the fuseholder devices 100D, 100E and 100F are connected together. Two vertical ridges are adjacent to one another, with their respective trapezoid-shaped top surfaces 420 interlocked together. To facilitate the interlocking of the two H-shaped protuberances, the protuberances, such as the back protuberance 402 and the front protuberance 404 on the left side of the housing 106 are not exactly aligned with the back and front protuberances on the right side of the housing. Instead, the h-shaped protuberances are shifted slightly and inverted to facilitate the interlocking 420 between two fuseholder devices. In exemplary embodiments, the locking mechanism of the novel fuseholder device 100 may support anywhere from two to n poles.

Recall from FIGS. 1 and 2 that the in-line fuseholder quick connection device 100 optionally includes the LED indicator 116. The LED indicator 116 indicates that the fuse has been bowed and should be replaced. The LED indicator 116 is thus particularly helpful when multiple fuseholders are connected together, as in FIG. 4B. In an exemplary embodiment, the in-line fuseholder quick connection device 100 includes these LED indicators 116 for easy fuse bowed identification when the fuseholders are used on multiple poles engaged by a press-system on the sides.

FIGS. 5A-5J are representative perspective diagrams of the in-line fuseholder quick connection device 100 of FIG. 1, according to exemplary embodiments. Where appropriate, some of the views are cutaway perspective views. Together, these diagrams present a sequence of operating the in-line fuseholder quick connection device 100. One or more of the operations depicted herein may be performed in a different order.

In the perspective view of FIG. 5A, the fuse carrier 104 is at an angled (open) position for receiving the fuse cartridge 102. The movement of the fuse carrier 104 from the horizontal (closed) position in the housing 106, such as in FIG. 2, to the angled position as shown may be achieved by lifting the lever 214 from the horizontal position. The left leverage cover 120 and the right leverage cover 122 are in the horizontal (closed) position.

In the perspective cutaway view of FIG. 5B, the fuse carrier 104 is still in the angled (open) position with the fuse cartridge 102 fully installed and starting to engage (connect) with the right fuse clip 204.

In the perspective cutaway view of FIG. 5C, the fuse carrier 104 is starting to return to the horizontal (closed) position in the housing 106. The fuse cartridge 102 is engaged with the right fuse clip 204 and is beginning to engage with the left fuse clip 202. Recall that the vertical portions of the fuse clips move slightly for receiving the fuse cartridge 102 and include convex surfaces to facilitate seating of the fuse cartridge within each fuse clip 202, 204.

In the perspective cutaway view of FIG. 5D, the fuse carrier 104 is nearly in its horizontal (closed) position in the housing 106. The fuse cartridge 102 is fully engaged with the right fuse clip 204 and substantially engaged with the left fuse clip 202.

In the perspective cutaway view of FIG. 5E, the fuse carrier 104 is in its horizontal (closed) position in the housing 106. The fuse cartridge 102 is fully engaged with the right fuse clip 204 and the left fuse clip 202. The right leverage cover 122 is moving from its horizontal (closed) position to an angled (open) position.

In the perspective cutaway view of FIG. 5F, the right leverage cover 122 remains in its angled (open position). The right wire 126 with exposed copper portion 112 moves leftward toward the housing 106 to be inserted through the hole 118 of the housing.

In the perspective cutaway view of FIG. 5G, the exposed copper portion 112 of the right wire 126 is fully inserted into the housing 106 through the vertically disposed rectangular opening 330 (not shown; see FIG. 3) of the right spring clamp 212. The copper portion 112 is disposed between the inward curl 334 and above the flattened cutout 332 of the right spring clamp 212. The copper portion 112 is also connected to the base 208 of the right fuse clip 204. The right leverage cover remains in the angled (open) position.

In the perspective cutaway view of FIG. 5H, the right leverage cover 122 is restored to a horizontal (closed) position, which pushes the right spring clamp 212 so that the top of the rectangular opening 330 (not shown; see FIG. 3) is flush against the base 208 of the right fuse clip, pushing the base against the exposed copper 112 or the right wire 126, enabling electrical flow therebetween. Meanwhile, on the left side of the housing 106, the left leverage cover 120 moves from the horizontal (closed) position to an angled position. The copper portion 110 of the left wire 124 moves in a rightward direction toward the opening 128 of the housing 126.

In the perspective cutaway view of FIG. 51, the left leverage cover 120 remains in the angled (open) position, with the copper portion 110 of the left wire 124 being threaded through the vertically disposed rectangular opening 330 (not shown; see FIG. 3) of the left spring clamp 210. The copper portion 110 is disposed beneath the inward curl 334 and above the flattened cutout 332 of the left spring clamp 210, thus fully engaged in the housing. The exposed copper portion 110 is also connected to the base 206 of the left fuse clip 202, enabling electrical flow therebetween.

In the perspective cutaway view of FIG. 5J, the left leverage cover 120 is restored to its horizontal (closed) position, which pushes the left spring clamp 210 so that the top of the rectangular opening 330 (not shown; see FIG. 3) is flush against the base 206 of the left fuse clip 202, pushing the base against the exposed copper 110 of the left wire. Thus, in FIG. 5J, the fuse cartridge 102 is in place, the left wire 124 is fully inserted into the housing 106, and the right wire 126 is fully inserted into the housing, such that the in-line fuseholder quick connection device 100 is connected to a circuit or other device and ready to operate.

As used herein, an element or step recited in the singular and proceeded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

While the present disclosure makes reference to certain embodiments, numerous modifications, alterations and changes to the described embodiments are possible without departing from the sphere and scope of the present disclosure, as defined in the appended claim(s). Accordingly, it is intended that the present disclosure not be limited to the described embodiments, but that it has the full scope defined by the language of the following claims, and equivalents thereof.

1. An in-line fuseholder quick connection device, comprising:
a housing;
a fuse carrier comprising a receiving chamber for inserting a fuse cartridge, the fuse carrier to move from a horizontal position along a top portion of the housing to an angled position extending outside the housing for receiving the fuse cartridge, the fuse carrier to further return to the horizontal position once the fuse cartridge is inserted inside the receiving chamber;
a first fuse clip for coupling to a first end of the fuse cartridge; and
a second fuse clip for coupling to a second end of the fuse cartridge.

2. The in-line fuseholder quick connection device of claim 1, the first fuse clip further comprising a first base for coupling to a first wire.

3. The in-line fuseholder quick connection device of claim 2, the second fuse clip further comprising a second base for coupling to a second wire.

4. The in-line fuseholder quick connection device of claim 3, further comprising:
a first spring clamp for clamping the first base to a first copper portion of the first wire; and
a second spring clamp for clamping the second base to a second copper portion of the second wire.

5. The in-line fuseholder quick connection device of claim 4, further comprising a first leverage cover adjacent to the fuse carrier, the first leverage cover to move from a horizontal position along the top portion of the housing to an angled position above the housing, the first leverage cover to return to the horizontal position once the first copper wire is coupled to the first base, wherein the first leverage cover causes the first spring clamp to clamp the first base to the first copper portion of the first wire.

6. The in-line fuseholder quick connection device of claim 5, further comprising a second leverage cover adjacent to the fuse carrier, the fuse carrier being in between the first leverage cover and the second leverage cover, the second leverage cover to move from a horizontal position along the top portion of the housing to an angled position above the housing, the second leverage cover to return to the horizontal position once the second copper wire is coupled to the second base, wherein the second leverage cover causes the second spring clamp to clamp the second base to the second copper portion of the second wire.

7. The in-line fuseholder quick connection device of claim 3, wherein the first fuse clip and the first base are formed from a single conductive material.

8. The in-line fuseholder quick connection device of claim 3, wherein the first fuse clip comprises two vertical portions each having concave surfaces for receiving the fuse cartridge.

9. The in-line fuseholder quick connection device of claim 6, wherein the first leverage cover and the second leverage cover comprise quick-release devices.

10. The in-line fuseholder quick connection device of claim 1, wherein the fuse carrier comprises a lever for lifting the fuse cartridge from the horizontal position to the angled position.

11. The in-line fuseholder quick connection device of claim 4, wherein the first spring clamp is formed by cold forming a rectangular metal piece, annealing the rectangular metal piece, cutting a small rectangular opening at one end, shaping the rectangular piece into a generally oval shape, including an inward curl of an end of the rectangular metal piece that is opposite the rectangular opening, and bending the small rectangular opening so as to be disposed horizontally under the inward curl.

12. The in-line fuseholder quick connection device of claim 1, further comprising an LED indicator, the LED indicator to indicate that the fuse is broken.

13. A method to connect an in-line fuseholder quick connection device to a circuit, the circuit comprising a first wire and a second wire, the method comprising:
moving a fuse carrier from a horizontal position in a housing to an angled position, wherein the fuse carrier extends above a top portion of the housing;
inserting a fuse cartridge into a receiving chamber of the fuse carrier, wherein the fuse cartridge is coupled to first and second fuse clips;
moving the fuse carrier back to the horizontal position in the housing; and
coupling the first wire to the housing.

14. The method of claim 13, connecting the first wire to the housing further comprising:
opening a first leverage cover of the housing, wherein the first leverage cover is at an angled position above the top portion of the housing, the first leverage cover being adjacent to the fuse carrier;
inserting an exposed first copper portion of the first wire through a first opening into the housing, wherein the first opening is beneath the first leverage cover; and
closing the first leverage cover of the housing.

15. The method of claim 14, further comprising:
pushing, by the first leverage cover, against a first spring clamp, wherein the first spring clamp causes a first base coupled to the first fuse clip to be compressed together with the first copper portion of the first wire.

16. The method of claim 14, further comprising:
opening a second leverage cover of the housing, wherein the second leverage cover is at an angled position above the top portion of the housing, the second leverage cover being adjacent to the fuse carrier, the fuse carrier being between the first leverage cover and the second leverage cover;
inserting an exposed second copper portion of the second wire through a second opening in the housing, wherein the second opening is beneath the second leverage cover; and
closing the second leverage cover of the housing.

17. The method of claim 16, further comprising:
pushing, by the second leverage cover, against a second spring clamp, wherein the second spring clamp causes a second base coupled to the second fuse clip to be compressed together with the second copper portion of the second wire.

18. The method of claim 17, wherein the second base coupled to the second fuse clip are formed of a single conductive material.

19. The method of claim 15, the first fuse clip further comprising a first vertical portion and a second vertical portion, the first and second vertical portions being coupled to the first base, wherein the first vertical portion and the second vertical portion separate from one another as the fuse cartridge is inserted into the first fuse clip.

20. The method of claim 13, wherein the fuse carrier is moved from the horizontal position in the housing to the angled position by lifting a lever of the fuse carrier.
